(19) United States
(12) Patent Application Publication
(10) Pub. No.: US 2018/0242167 A1
(43) Pub. Date: Aug. 23, 2018

(54) Radio Base Station

(71) Applicant: Telefonaktiebolaget LM Ericsson (publ), Stockholm (SE)

(72) Inventors: Giulio Bottari, Pisa (IT); Filippo Ponzini, Pisa (IT)

(21) Appl. No.: 15/751,902

(22) PCT Filed: Aug. 20, 2015
(86) PCT No.: PCT/EP2015/069185

§ 371 Date: Feb. 12, 2018

(51) Int. Cl. H04W 16/24; H04W 28/16; H04W 28/02

(52) U.S. Cl. CPC H04W 16/24; H04W 88/085; H04W 28/0231; H04W 28/16

(57) ABSTRACT

A Radio Base Station (101; 601) for a radio telecommunications network (100) comprising a Radio Unit (103) configured to transmit and receive radio telecommunication signals and a switch unit (104). The Radio Base Station further comprises a local Digital Unit (105) configured to process digital baseband signals received from the Radio Unit (103) and generate digital baseband signals sent to the Radio Unit (103). The Radio Base Station further comprises an external communications interface (112) configured to connect at least one remote Digital Unit (106, 107) to the Radio Unit (103) of the Radio Base Station. The switch unit(104) is configured to selectively connect the Radio Unit (103) with the local Digital Unit (105) or the external communications interface (112).

### TECHNICAL FIELD

The present application relates generally to a radio base station, and a method for operating a radio base station in a radio access network.

### BACKGROUND

In traditional Radio Access Networks (RAN), radio and baseband (BB) processing functionalities are integrated inside a Radio Base Station (RBS). An antenna module may be integrated or located in the proximity of the RBS. The RBS is connected to a Base Station Controller (BSC) in the case of Global System for Mobile Communications (GSM) architecture, a Radio Network Controller (RNC) in the case of Universal Mobile Telecommunications System (UMTS) architecture, or directly to the Evolved Packet Core (EPC) network entities e.g. a Serving Gateway for the user plane interface and a Mobility Management Entity (MME) for the control plane interface in the case of LTE.

RAN architecture is known to separate the analogue radio communication functionalities and the digital baseband processing functionalities into two separate entities, termed a Remote Radio Unit (RRU) and Digital Unit (DU) respectively. The RRU and DU are connected by an interface configured to pass digital signals providing the radio signals received or for transmission. For example, the radio signals are in the form of I/Q data. An open interface may be employed to enable equipment from different vendors to be interconnected. An example for communication among RRUs and DUs is the Common Public Radio Interface (CPRI). An alternative interface is Open Base Station Architecture Initiative (OBSAI).

FIG. 1 shows a prior art Remote Radio Unit 12 connected to a separate Digital Unit 16 via a CPRI link 14. A backhaul link 18 connects the DU to the rest of the network. An antenna element 102 is connected to the Remote Radio Unit 12.

Referring to FIG. 2, the decomposition of an RBS into the separate physical entities of RRU and DU provides for the baseband processing task to be performed by a centralized plurality of DUs 32, 34, 36 at one site, which may be termed a Baseband Hotel (BBH) 38. In some examples, the BBH 38 is controlled by a central control unit 30. A RRU 26 is connected to the BBH 38. An antenna element 102 is connected to the RRU 26. The RRU 26 shown is an example only, the RAN may comprise a plurality of RRUs connected to the BBH 38. The RAN including RRUs may be considered as, or as part of, a Coordinated-RAN or Centralised-RAN (C-RAN) 24. In this arrangement, there is provided baseband processing centralisation which facilitates coordination among adjacent cells. Said coordination is important to minimise inter-cell interference and to utilise interference paths constructively.

The network segment which is in charge of connecting RRUs 26 and DUs 32, 34, 36 is commonly known as fronthaul (FH) 14, 28. CPRI flows, at different granularities, can be transported across the fronthaul area over physical media, for example, optical channels or microwave links.

In FIG. 2, the BBH is depicted being connected directly via backhaul 18 to a core network 20, which represents the logical connection for an LTE eNodeB with the core network. If the RAN is UMTS then the BBH serving the NodeB would be logically connected to an RNC, and if it is GSM a Base Transceiver Station (BTS) would be connected to the core network via a BSC. The term base station or radio base station may be used to refer to an implementation of any of an eNodeB, NodeB, BTS or other logical radio network node.

Full radio coordination benefits from centralized processing and extremely low latency links between DUs and RRUs. This means that the way in which the transport layer of the RAN is realised has an impact on the coordination level that can be enabled. For example, a highest level of coordination may require centralized processing, with CPRI links used to connect RRUs and DU. Coordination is becoming more and more important for RAN evolution towards 5G because it allows augmenting spectrum efficiency and thus increasing supported traffic density in an area.

### SUMMARY

A first aspect of the disclosure provides a Radio Base Station for a radio telecommunications network comprising a Radio Unit configured to transmit and receive radio telecommunication signals and a switch unit. The Radio Base Station further comprises a local Digital Unit configured to process digital baseband signals received from the Radio Unit and generate digital baseband signals sent to the Radio Unit; and an external communications interface configured to connect at least one remote Digital Unit to the Radio Unit of the Radio Base Station. The switch unit is configured to selectively connect the Radio Unit with the local Digital Unit or the external communications interface.

Thus, a radio base station allows a change in baseband processing between processing in the radio base station, or in a remote digital unit in order to function as a RRU.

A second aspect of the disclosure provides a method in a Radio Base Station, comprising transmitting and receiving radio telecommunication signals using a radio unit, and communicating digital baseband signals between the radio unit and one of a local Digital Unit and an external communications interface. The external communications interface connects the radio unit to at least one remote Digital Unit. The method comprises selecting a different connection for the digital baseband signals, such that the digital baseband signals are communicated between the radio unit and the other of the local Digital Unit and the external communications interface.

A third aspect of the disclosure provides a method in a Radio Access Network, comprising measuring one or more parameter; and determining for a radio base station a connection for digital baseband signals to be communicated between a radio unit and a local Digital Unit or at least one remote Digital Unit. The determining is based on the one or more parameter. The method comprises transmitting a control signal to a switch unit of the radio base station controlling the connection between the radio unit and the local Digital Unit or the at least one remote Digital Unit. The determined connection for the digital baseband signals is controlled by the control signal.

A fourth aspect of the disclosure provides a control unit for a Radio Access Network, comprising a parameter unit configured to determine one or more parameter and a determining unit configured to determine for a radio base station a connection for digital baseband signals to be communicated between a radio unit and a local Digital Unit or between the radio unit and at least one remote Digital Unit. The determining unit is configured to determine based on the one or more parameter. The control unit further comprises a transmitting unit configured to transmit a control signal to the radio base station to select the connection for the digital baseband signals.

A further aspect of the disclosure provides a computer program product, configured when operated in a part of a wireless telecommunications network, to perform a method according to any example of the disclosure.

### BRIEF DESCRIPTION OF THE DRAWINGS

Embodiments of the present disclosure will now be described, by way of example only, with reference to the accompanying drawings in which:

FIG. 1 shows a prior art configuration of a Remote Radio Unit with external baseband processing;

FIG. 2 shows a prior art configuration of a Radio Access Network including a Remote Radio Unit and centralised DUs (BBH);

FIG. 3 shows an example RBS configuration according to an embodiment of the disclosure.

FIG. 4 shows a Radio Access Network comprising a hybrid RBS configured according to an embodiment of the disclosure and a C-RAN architecture;

FIG. 5 shows an example flowchart illustrating steps according to an aspect of the disclosure;

FIG. 6 shows a further example flowchart illustrating steps according to an aspect of the disclosure;

FIGS. 7a and 7b show an example of cell cluster coordination according to an aspect of the disclosure;

FIG. 8 shows a further example RBS configuration according to an embodiment of the disclosure;

FIGS. 9a, 9b and 9c show example RBS configurations according to further embodiments of the disclosure;

FIG. 10 is a schematic overview of a Radio Access product according to an example of the disclosure;

FIG. 11 is a further schematic overview of a Radio Access product according to an example of the disclosure;

FIG. 12 shows an example of a process according to an embodiment of the disclosure;

FIG. 13 shows a further example of a process according to an embodiment of the disclosure;

FIG. 14 is a schematic overview of an apparatus according to an example of the disclosure.

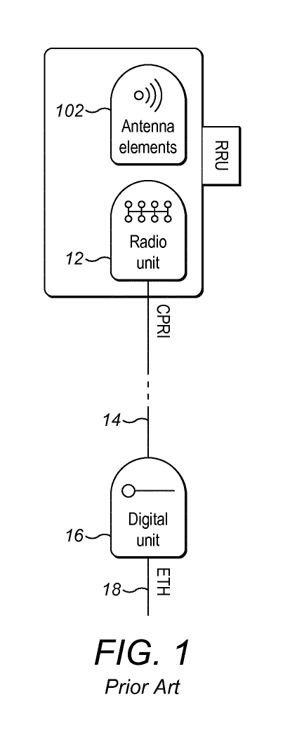

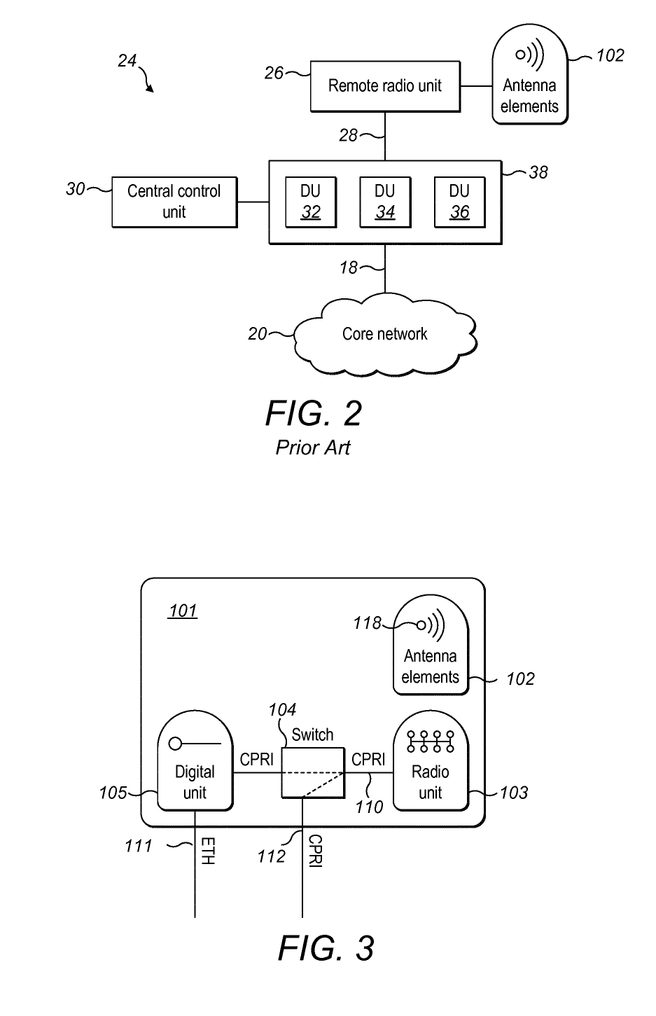

### DETAILED DESCRIPTION

In FIG. 3, a RBS 101 is shown according to an exemplary embodiment. The RBS 101 may be referred to as a hybrid RBS 101, having the functions of both a conventional RBS and a conventional RRU. The hybrid RBS 101 is configured to function as a conventional RBS, providing integrated baseband processing of radio signals. The hybrid RBS 101 is also configured to function as an RRU. In this function, hybrid RBS 101 communicates radio signals with a separate DU for baseband processing.

The hybrid RBS 101 comprises a Radio Unit (RU) 103 and a local Digital Unit (DU) 105. The RU 103 and DU 105 are both located within the same base station, and may be considered as integrated or in the same physical location. The RU 103 and DU 105 communicate radio signals with each other, for example, digital radio signals. The radio signals may be I/Q data, e.g. using CPRI.

The DU 105 is configured to output and receive signals through a backhaul interface 111, also termed a network interface 111. The backhaul interface 111 may provide a connection to a core network, either directly or through one or more controller nodes (e.g. an RNC node). The signals on the backhaul interface 111 may be transmitted as packets, for example, in an Ethernet connection. The signals transmitted on the backhaul interface 111 have been baseband processed by the DU 105, or signals received for baseband processing by the DU 105. Thus, the signals received/transmitted on the backhaul interface 111 are not representations of radio signals.

The hybrid RBS 101 further comprises an external communications interface 112 configured to connect at least one remote DU to the hybrid RBS. In particular, the external communications interface 112 provides a connection between the RU 103 in the hybrid RBS 101 and an external, remote, baseband processing. The external communications interface 112 is configured to communicate radio signals with an external DU, for example, digital radio signals. The radio signals may be I/Q data, e.g. using CPRI. Thus, the external communications interface 112 may be considered as a CPRI interface of the hybrid RBS 101. The external communications interface 112 handles a different type of data than the backhaul link 111.

The hybrid RBS 101 further comprises a Switch Unit 104. The Switch Unit 104 is configured to selectively connect the RU 103 with either the local DU 105 or with the external communications interface 112. The switch unit 104 handles radio signals, or a representation of radio signals. For example, the switch unit 104 switches I/Q data, e.g. using CPRI.

Thus, the switch unit 104 provides for a selection of one of two modes of operation of the hybrid RBS 101. In a first mode, the switch unit 104 selectively connects the RU 103 to the local DU 105. Thus, radio data (e.g. CPRI) is communicated between the local DU 105 and the RU 103. The hybrid RBS 101 functions as a conventional RBS, having integrated baseband processing and a backhaul interface 111.

In a second mode, the switch unit 104 selectively connects the RU 103 to the external communications interface 112. Thus, radio data (e.g. CPRI) is communicated between a remote DU, via the external communications interface 112, and the RU 103. The hybrid RBS 101 functions as a conventional RRU, having remote baseband processing.

The switch unit 104 provides for two way communication between the RU and the connected DU (local or remote). The example in FIG. 3 shows the switch unit as a separate entity; however the switch unit 104 may be considered as a logical function. The logical function may be separate or within other entities of the hybrid RBS. The function of the switch unit 104 may be achieved through a hardware, firmware or software implementation. The switch may be of any type suitable for selectively connecting received data to an intended output port. The switch unit is configured to select a connection, or selectively connect, either the local DU or remote DU to the RU.

In some examples, the hybrid RBS 101 further comprises at least one antenna element 102. The antenna element(s) 102 are configured to connect the RU 103 to an antenna 118. The antenna element(s) and antennas handle signals which are, or represent, radio signals. The antenna element(s) 102 and antenna 118 are common to the RU, and handle radio signals which are processed either in the integral DU 105 or in the remote DU. The antenna element(s) 102 and/or antenna 118 may be integrated with the hybrid RBS 101, or may be remote. The location of the antenna element(s) 102 and/or antenna 118 does not affect the two modes of functioning of the hybrid RBS 101 described.

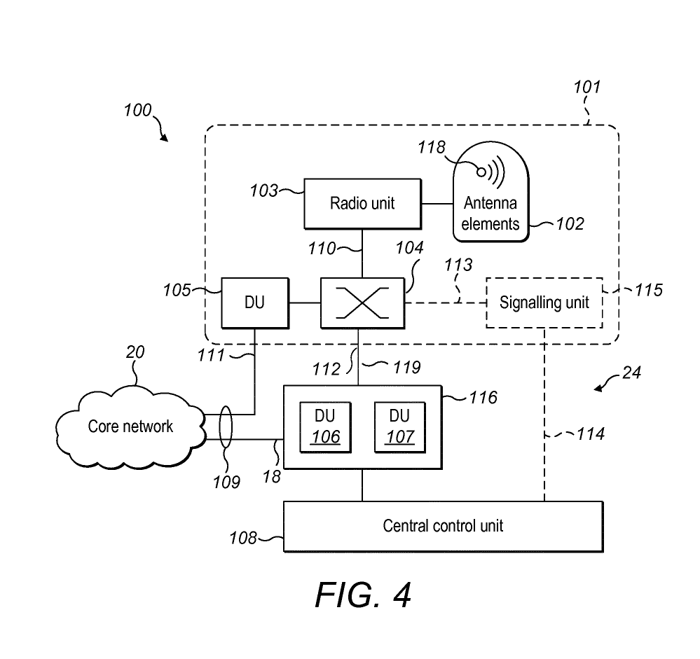

FIG. 4 shows the hybrid RBS 101 arranged in a Radio Access Network 100. As described above, the hybrid RBS 101 has its own, local, DU 105 and radio unit 103. The radio unit 103 is connected to the switch unit 104 with a connection 110 carrying radio data, e.g. in CPRI format. The antenna elements 102 connect the radio unit 103 and the antenna 118. In use, the hybrid RBS 101 is connected to a Baseband Hotel (BBH) 116. The BBH 116 is configured to provide pooled baseband processing. In some examples, the BBH 116 comprises a plurality of DUs. As an example, DUs 106, 107 are shown, and the BBH 116 may comprise further DUs.

The BBH 116 may be considered as part of a C-RAN 24. A Central Control Unit 108 may be connected to the BBH 116. In some examples, the central control unit 108 is further connected to the hybrid RBS 101. For example, the hybrid RBS 101 comprises a signalling unit 115 configured to receive control signals from the central control unit 108. In some examples, the control signals are configured to trigger the hybrid RBS 101 to set or change the switch unit 104, to select between local baseband processing by the DU 105 and processing of baseband signals within the BBH 116. The signalling unit 115 may be connected to the switch unit 104 by a link 113, or may be integrated in the switch unit 104.

The hybrid RBS 101 may receive control signals on a logical control link 114 between the central control unit 114 and the signalling unit 115. The control link 114 may use the same physical link and communication channel as the radio data or backhaul data. In an alternative example, the hybrid RBS 101 does not comprise a separate signalling unit. In some examples, the communication between the switch unit and the control unit is bi-directional.

In some examples, the central control unit 108 determines whether (and optionally the amount) of the baseband processing to be carried out by the local DU 105 and the remote DUs 106, 107. For example, criteria for determining the location of baseband processing are described below. The central control unit 108 may make the determination autonomously, or following communication with a network management system or communication with the RU 103. For example, the RU 103 may monitor the associated local DU 105, and request the central control unit 108 to transfer baseband processing to the BBH 116, e.g. in the event that a parameter of the local DU 105 does not meet a threshold, e.g. cannot provide the baseband data in time.

In some examples, a parameter or status of the Hybrid RBS is determined by the Hybrid RBS itself. The hybrid RBS may transmit the parameter or status to the central control unit, in order for the central control unit to make a mode selection decision. In some examples, the hybrid RBS processes data in order to generate the parameter. Alternatively, the hybrid RBS may determine a mode of the switch unit autonomously, i.e. without receiving a determination an external node. In some examples, the hybrid RBS may notify the central control node, one or more further RBSs and/or further nodes of the determination. In some examples, the central control unit is located in, e.g. embedded, in a RBS, e.g. the hybrid RBS 101. In this case, there is no central control unit, and the control functions described are carried out by one or more of the RBS.

The hybrid RBS 101 has a backhaul interface 111 for communication between the local DU 105 and a backhaul connection 109 and core network 20. The BBH 116 has a further backhaul interface 18 to the core network 20. The backhaul interfaces 18, 111 may be connected to the core network by one or more backhaul connection 109. Thus, the hybrid RBS 101 and BBH 116 have separate ports or interfaces 18, 111 for backhaul traffic. The port used will depend on whether the baseband processing is carried out in the hybrid RBS 101 or in a remote DU (e.g. in the BBH 116).

A DU 106, 107 or BBH 116 is configured to communicate data with the external communications interface 112. A communications link 119 is configured to carry baseband radio data between the DU 106, 107 or BBH 116 and the external communications interface 112 of the hybrid RBS 101. As described above, the data may be in the form of digitized radio signals, e.g. using CPRI signals.

The hybrid RBS 101 is shown having separate interfaces for fronthaul and backhaul 111, 112. These separate interfaces are logical. The hybrid RBS 101 may use a same physical channel, e.g. an optical channel or optical fiber, to transmit both radio signals (e.g. CPRI) or packet data (e.g. Ethernet in backhaul) according to the assigned operating mode.

The arrangement described enables a network operator to offload part or all of the baseband processing effort from a hybrid RBS (i.e. by the local DU 105) to a centralised pool of baseband processing (i.e. by BBH 116), or vice versa, according to current or foreseen traffic conditions. The offload direction and amount of baseband traffic offloaded can change dynamically, i.e. over time. This provides for flexibility in baseband processing resource allocation, for example, allowing changing coordination requirements or varying traffic loads to be handled.

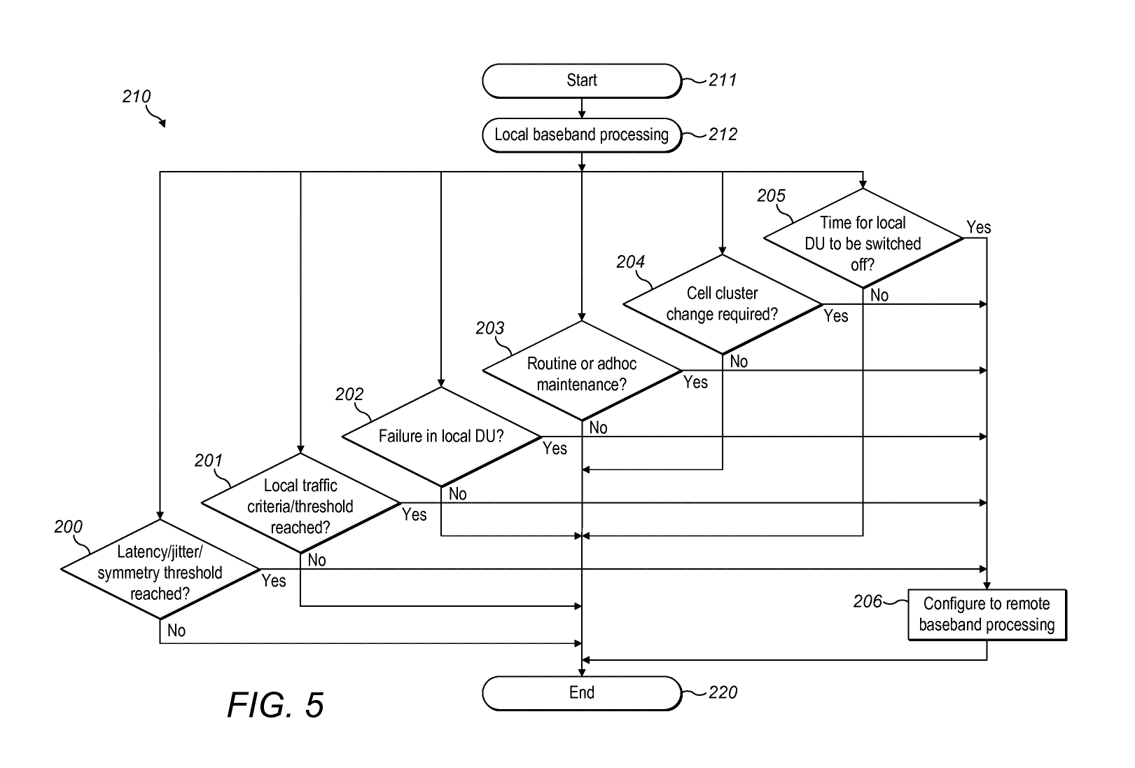

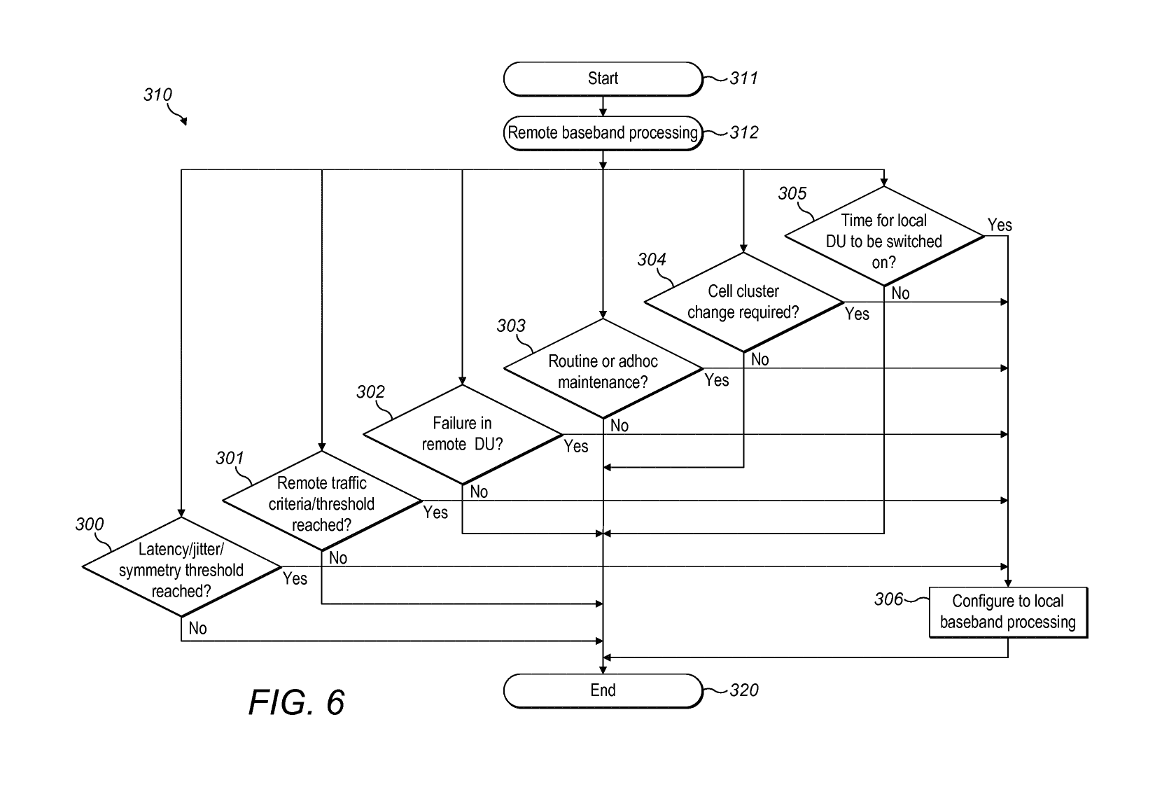

FIGS. 5 and 6 show flowcharts providing examples of decision criteria to change the baseband processing between centralised (remote) DU, pool processing, and the local DU, i.e. within the hybrid RBS 101. There is no requirement for a method to make the decisions in a particular order, or that all or any combination of tests is essential. FIGS. 5 and 6 portray a non-exclusive, exemplary, list of criteria which may be followed in determining the decision to switch the location of baseband processing.

In some aspects, the method comprises selectively connecting the Radio Unit with either a local Digital Unit 105 in the hybrid RBS; or with at least one remote Digital Unit 106, 107, located remotely from the Radio Unit 103 and the local Digital Unit 105. The determination in the hybrid RBS to switch between communication of the radio unit with the local DU or remote DU may be based on a received control signal, e.g. from the central control unit, or made autonomously. The determination to switch DUs may be based on one or more measurements, e.g. of the radio access network, and/or based on predetermined criteria, e.g. which are independent of the current state of the radio access network.

FIG. 5 shows a method 210 of determining whether to change baseband processing from local baseband processing (i.e. in the hybrid RBS) to remote baseband processing (i.e. in a centralized BBH 116). The method starts at 211, in which the DU is carrying out at least some local baseband processing 212. A determination to move baseband processing location (i.e. to the remote DUs) is made if the criteria described are being met, or are expected to be met in the future.

In 200, a determination of changing baseband processing location is made, based on one or more radio signal transport requirements, e.g. CPRI requirements. For example, the requirements may be one or more of latency, jitter and or symmetry. These are requirements on the physical infrastructure, e.g. processing of the digitized radio signals, and their communication between the RU and local DU 105. For example, the requirement value is compared with a threshold. If the comparison indicates that the requirement value is better than the threshold, e.g. below the threshold, then a determination is made to transfer baseband processing to the remote DUs. This provides for transfer of baseband processing when the requirement (e.g. latency requirement) is not stringent. Thus, the baseband processing may be moved to the remote DUs, in a case when the local DU (and remote DUs) are able to satisfy the requirement.

Alternatively, a determination is made of whether the requirement value (e.g. latency) is worse than (e.g. above) a threshold which indicates a minimum performance or quality. For example, a determination is made on whether the local DU is able to deliver the expected baseband data in time. If this threshold is reached, the baseband processing may be moved to the central processing site to receive a better service.

In 201, a determination of the traffic load on the local DU 105 is made. If the traffic load is determined to be above a threshold, a part or all of the traffic load is transferred to the remote DUs 106, 107. In a further example, if the traffic load is below a threshold, traffic load is transferred to the remote DUs. This may allow the local DU to be switched off.

In 202, a determination of a failure in the DU 105 may be made. In the event of the failure, all or part of the traffic load is transferred to the remote DUs 106, 107.

In 203, a determination of reduced or stopped baseband processing capacity in the DU 105, due to maintenance, may be made. The maintenance may be routine or ad-hoc. In the event of the maintenance, all or part of the traffic load is transferred to the remote DUs 106, 107.

In 204, a determination is made of a change in cell cluster. For example, a cell cluster, or coordination cluster, of RRUs and/or RBSs may utilize the same baseband processing resources in order to achieve high levels of coordination. By changing the baseband processing from the local DU to a centralized baseband processing, e.g. in BBH 116, the cell cluster may be supported. In some examples, the allocation of cells to a cluster may change dynamically, e.g. due to cell load or other scheduling criteria, such as time-of-day.

In 205, a determination is made of a time for the local DU to be switched off, and the centralized baseband processing takes over baseband processing functions. The time may be related to an expected traffic load at that time of the day and/or week. For example, the local DU may be switched off when low traffic levels are expected, e.g. at night. This criterion relates to power management of remote radio units. The power consumption at the cell site can be reduced, e.g. at night, by switching off the local DU and moving the residual baseband processing to the centralized pool of BBH 116. For example, this facilitates the use of solar power supply at cell (i.e. RBS 101) sites. As such, the switching between local and remote modes may be performed based on a time schedule.

In 206, a determination is made, e.g. by the central control unit 108, that baseband processing should be transferred from the local DU 105 to the centralized baseband processing, e.g. BBH 116. The central control unit 108 communicates this determination to the hybrid RBS 101, e.g. to at least the switch unit 104. At least some of the radio signals are then sent between the remote DUs 106, 107 and the RU 103, instead of between the local DU 105 and the RU 103.

If a determination is made that transfer of baseband processing to the remotes DUs is not required, based on any of these criteria, then the local DU 105 continues with baseband processing. In this case, the method ends at 220.

There can be other criteria upon which a decision to switch may be made such as a need to switch between local baseband processing and processing in a centralised pool if a certain aspects of the processing are not handled by the remote RBS, for example the channel conditions allow multiple antenna support and the associated baseband processing is not supported in the local DU 105 then a decision to move the processing to the centralised baseband processing is made.

FIG. 6 shows a method 310 of determining whether to change baseband processing from remote baseband processing (e.g. in a centralized BBH 116) to local baseband processing (i.e. in the RBS). The method starts at 311, in which the remote baseband processing is carrying out at least some remote baseband processing 312. A determination to move baseband processing location (i.e. to the local DU) is made if the criteria described are being met, or are expected to be met in the future.

In 300, a determination of changing baseband processing location is made, based on one or more radio signal transport requirements, e.g. CPRI requirements. For example, the requirements may be one or more of latency, jitter and/or symmetry. These are requirements on the physical infrastructure, e.g. processing of the digitized radio signals, and their communication between the RU and remote DUs 106, 107. For example, a determination may be made on whether the remote DUs 106, 107 are able to meet traffic requirements, e.g. deliver the expected baseband data in time. If not, the baseband processing may be moved to the local DU 105 to receive a better service. For example, if the requirement (e.g. latency) is determined to above a threshold (i.e. the requirement is satisfied), processing is transferred to the local DU. This may occur if the requirement is stringent.

In 301, a determination of the traffic load on the remote DUs 106, 107 is made. If the traffic load is determined to be above a threshold, a part or all of the traffic load is transferred to the local DU 105. For example, the baseband processing may be moved back from the centralised pool to local DUs to decongest transport network resources when, for example, the traffic exceeds a threshold. The threshold may be the same threshold or a different threshold (e.g. higher) than the threshold used in step 201. In a further example, if the traffic load is below a threshold, traffic load is transferred to one or more local DUs. This may allow one or more of the remote DU to be switched off.

In 302, a determination of a failure in the DUs 106, 107 may be made. In the event of the failure, all or part of the traffic load is transferred to the local DU 105.

In 303, a determination of reduced or stopped baseband processing capacity in the DUs 106, 107, due to maintenance, may be made. The maintenance may be routine or ad-hoc, e.g. required un-planned maintenance. In the event of the maintenance, all or part of the traffic load is transferred to the local DU 105. Typically if the failure is part of a pool configuration, a new DU 106, 107 from within the pool i.e. BBH 116) can be allocated. In the event that this is not available, the baseband processing may be moved (e.g. temporarily) back to the local DU 105 within the hybrid RBS.

In 304, a determination is made of a change in cell cluster. For example, a cell cluster, or coordination cluster, of RRUs and/or RBSs may utilize the same baseband processing resources in order to achieve high levels of coordination. By changing the baseband processing from the centralized baseband processing, e.g. in BBH 116, to the local DU, a cell cluster may be supported. In some examples, the allocation of cells to a cluster may change dynamically, e.g. due to cell load or other scheduling criteria, such as time-of-day.

In 305, a determination is made of a time for the local DU to be switched on, to take over some baseband processing functions from the centralized baseband processing. The time may be related to an expected traffic load at that time of the day and/or week. For example, the local DU may be switched on when high traffic levels are expected, e.g. during the day. This criterion relates to power management of remote radio units. The power consumption at the cell site can be reduced, e.g. at night, by switching off the local DU and moving the residual baseband processing to the centralized pool of BBH 116. Switching the local DU on provides for increased processing capacity.

In 306, a determination is made, e.g. by the central control unit 108, that baseband processing should be transferred to the local DU 105, from the centralized baseband processing, e.g. BBH 116. The central control unit 108 communicates this determination to the RBS 101, e.g. to at least the switch unit 104. At least some of the radio signals are then sent between the local DU 105 and the RU 103, instead of between the remote DUs 106, 107 and the RU 103. If a determination is made that transfer of baseband processing to the local DU is not required, based on any of these criteria, then the remote DUs 106, 107 continue with baseband processing. In this case, the method ends at 320.

Alternatively, the baseband processing may be switched between local baseband processing and processing in a centralised pool if a certain aspect of the processing is not handled by the current local DU or remote DU, for example, specific baseband processing required for dual band or Multi-Antenna processing not being supported by the local DU but supported by the centralised baseband pool, or vice versa.

In some examples, the condition of the radio or transport infrastructure can determine the moving baseband processing locally (by DU 105) or remotely (e.g. by DUs 106, 107). Such examples are: under-provisioned baseband at macro site, link failures or degradations, and/or violations of CPRI required transmission constraints.

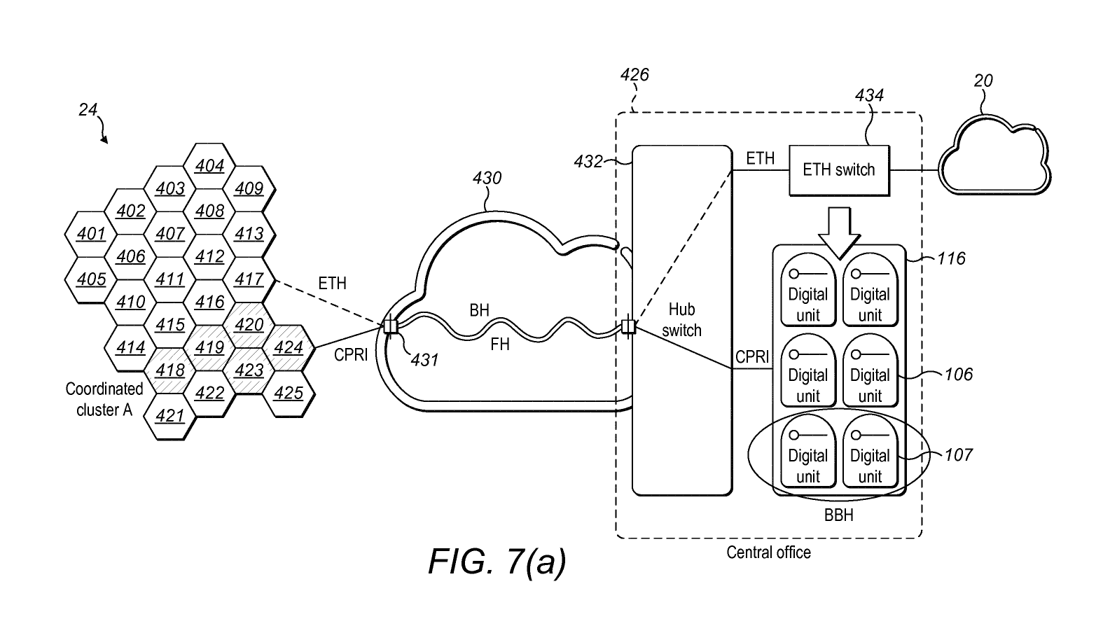

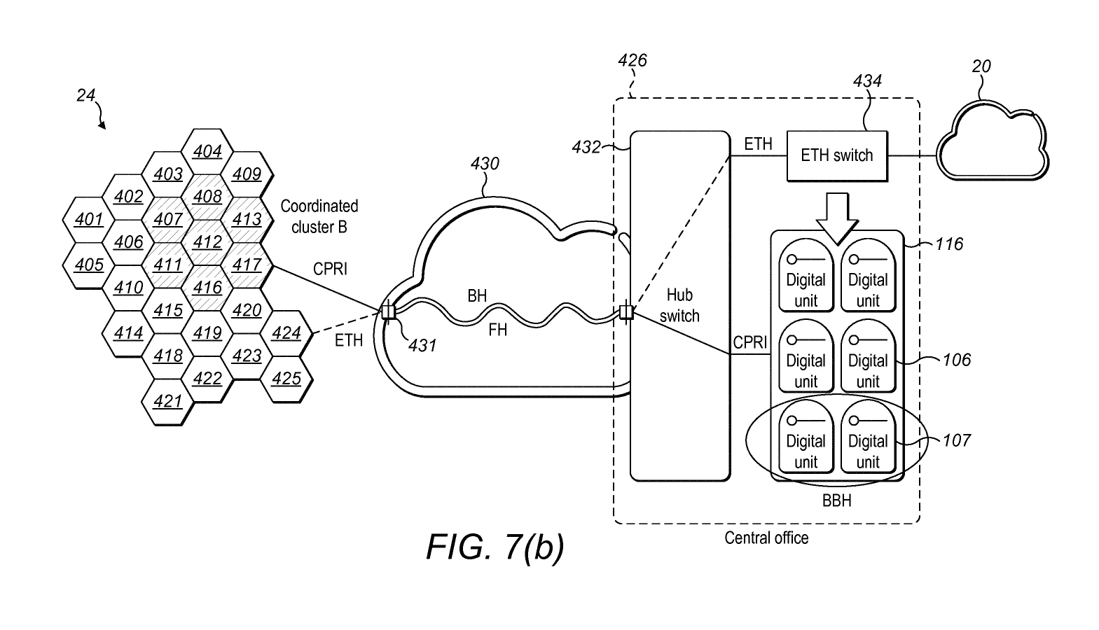

FIGS. 7a and 7b show an implementation of the hybrid RBS 101 for supporting dynamic coordination clusters. As previously described, an embodiment includes the dynamic switching based on cell cluster requirements 204, 304, providing for a high level of flexibility in performing baseband processing at cell site or at central site. This allows dynamically building or dismantling coordination clusters in a given area. For instance, radio coordination can be performed on a time basis defining dynamic coordination clusters, by enabling DU centralisation only if and where necessary.

The radio access network 24 comprises a plurality of cells 401-425. Each cell 401-425 is served by a base station or RRU, at least one of which is a hybrid RBS 101 as described above. The cells 401-425 are connected to a central office 426 by a communications link or transport network 430. The transport network 430 is configured to handle both radio data as fronthaul (e.g. CPRI) and backhaul data (e.g. packet data, for example, Ethernet). In some examples, the transport network 430 is an optical network. The central office 426 comprises the baseband hotel 116, having DUs 106, 107, as described above. In some examples, radio data and/or backhaul packet data is collected for transport to the central office 426 at one or more remote node 431. In some examples, the remote node 431 aggregates radio data (Fronthaul, FH) and/or backhaul (BH) packet data from one or more cells for transport over the transport network 430. For example, the remote node 431 aggregates data onto a same optical channel or wavelength.

In some examples, the central office 426 comprises a hub switch 432. A function of the hub switch 432 is to switch fronthaul data flows (e.g. CPRI) to the baseband hotel 116, and to switch backhaul data flows (e.g. Ethernet) to a packet switch 434. The packet switch 434 connects the central office with the backhaul or core network 20. Traffic for which baseband processing has been carried out in the BBH 116, or for which baseband processing will be carried out, is also transmitted through the packet switch 434.

FIG. 7a shows an example where an embodiment is applied to provide separate cell cluster baseband processing. The radio access network comprises a plurality of radio base stations, at least one of which is according to an example of the disclosure. For example, a first group of cells 418, 419, 420, 423, 424 are configured such that baseband processing is carried out at the centralized DUs 106, 107, i.e. common baseband processing pool. The configuration may be carried out by a central control entity transmitting signalling to each radio base station. Baseband signal connectivity may be achieved via CPRI. The cells may be coordinated cells, e.g. sending coordinated radio transmission.

A second group of cells 401 to 417 and 421, 422, 425 are configured such that baseband processing is done separately in the local DU of each RBS. In some examples, ethernet clients are transported in optical channels (backhaul) across the optical network. As described, the location of the baseband processing may be changed for a hybrid RBS 101.

FIG. 7b shows the result of a change in baseband processing location, e.g. as implemented by the switch unit in each hybrid RBS. A different connection is selected for the digital baseband signals of one or more of the radio base stations to modify the group of one or more radio base stations which are connected to the common baseband processing pool.

This change of switch configuration, for example under the control of the central control unit, provides for building different coordination clusters. The different coordination clusters may add cells to other clusters or create new clusters of cells. In this example, a new coordination cluster of a third group of 407, 408, 411, 412, 413, 416, 417 is created. The third group of cells have baseband processing is carried out at the centralized DUs 106, 107. The further cells, including those of the first group, use their local DU 105 for baseband processing.

Dynamically adapting coordination clusters allows for reserving centralized baseband processing for cells which require such centralized processing, e.g. for coordination. Thus, network resources, e.g. high bandwidth and low latency network resources are used only if necessary. Coordination clusters definition can be decided by the central control node or other entity, that has visibility of radio coordination requirements.

FIG. 8 shows a further configuration of hybrid RBS 500. The hybrid RBS 500 comprises an additional radio data interface 501, e.g. for communication digitized radio I/Q data, for example, CPRI. The interface 501 is configured to communicate with one or more separate RRU or a further hybrid RBS 101. The hybrid RBS 500 is configured to process baseband signals from such a separate RRU. The internal DU 502 of the hybrid RBS 500 is configured to accept radio data (e.g. CPRI) flows from nearby or co-located RRUs via the additional radio data interface 501. This configuration can be used, for example, in a multi-sector scenario in which the hybrid RBS is in charge of one sector, while one or more RRUs are in charge of other sectors.

In some examples, the radio data interface 501 provides a direct connection to the local Digital Unit 502. Alternatively, the radio data interface 501 is connected to the switch unit 104. The switch unit 104 is configured to switch radio data relating to the one or more separate RRU with either the local DU 502 or with the centralized DUs 106, 107.

In some examples, the RBS 500 has one or more radio data ports (e.g. CPRI interfaces) for the connection of additional RRUs in order to add frequency bands or sectors. Such implementations may include a high-capacity DU (baseband unit) which supports a large number of connected users. Implementations may also support Small Form-factor Pluggable SFP) optical transceivers for backhauling traffic from the RBS and/or (one or more of the associated separate RRUs, for example, using Ethernet-over-fiber or a wireless connection.

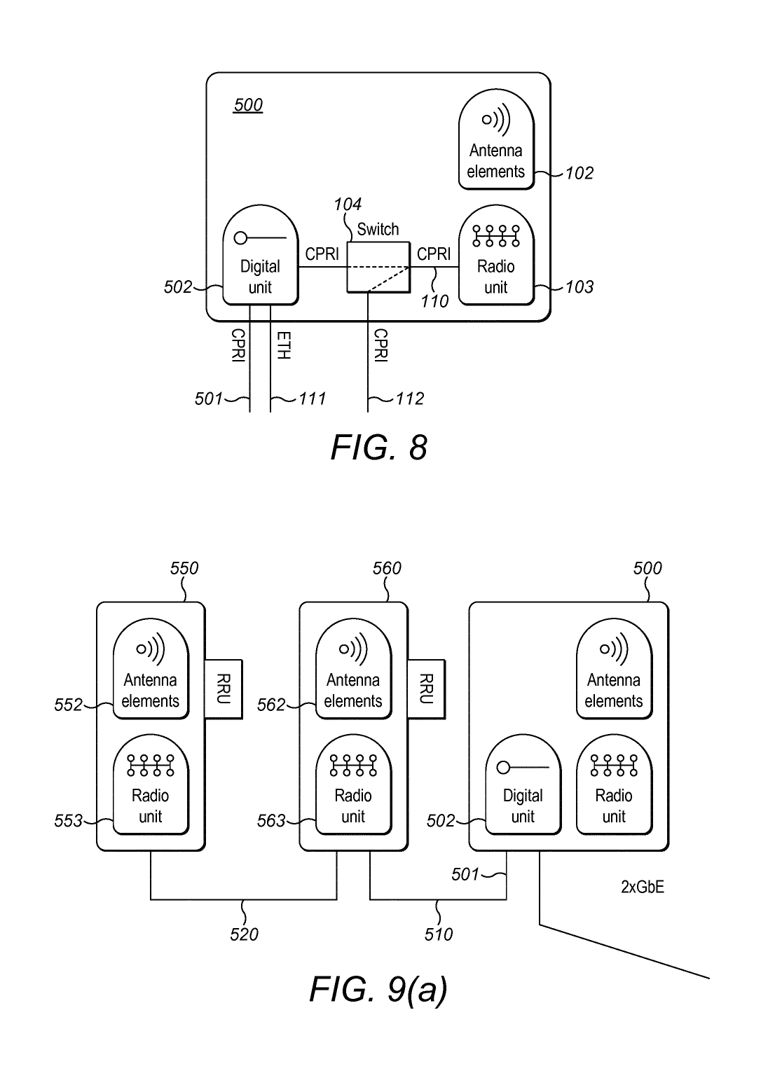

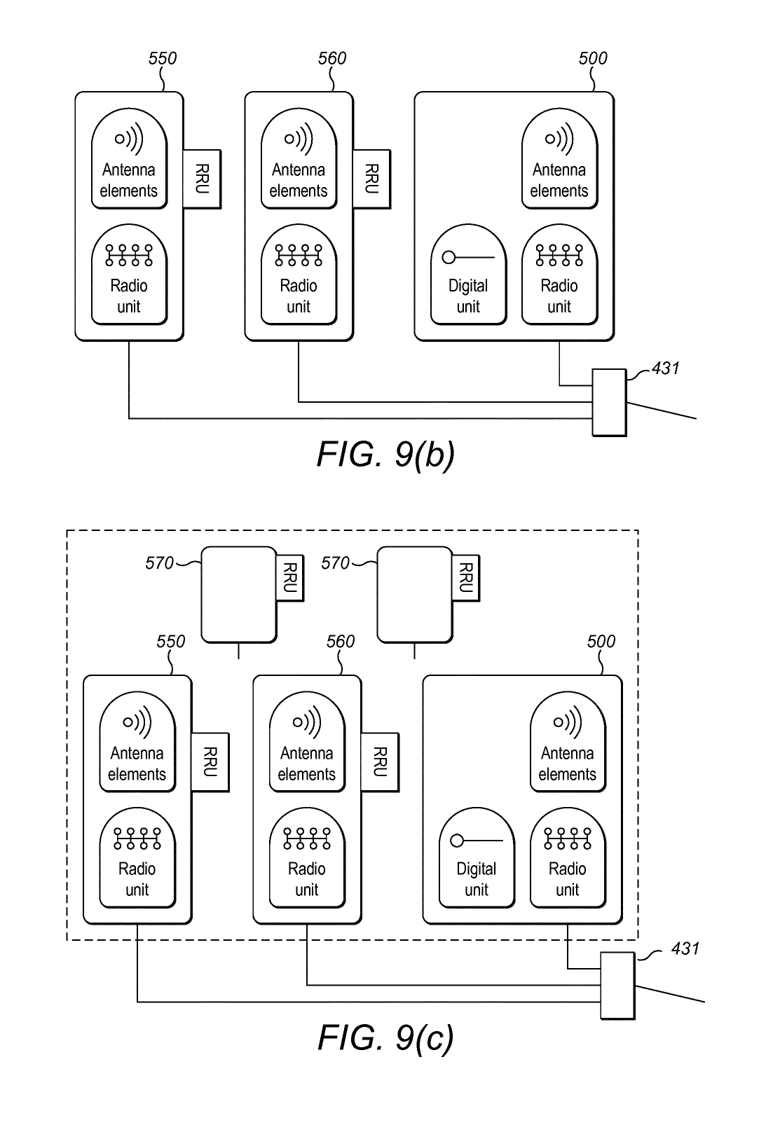

FIGS. 9a, 9b and 9c shows three examples of system comprising a hybrid RBS 500 comprising the radio data interface 501, and one or more separate RRUs 550, 560.

FIG. 9a shows the hybrid RBS 500 connected to a first RRU 560 with a first radio data link 510. The radio data link 510 connects to the radio data interface 501 of the hybrid RBS 500. The first RRU 560 comprises a radio unit 563 connected to the first radio data link 510. The first RRU 560 further comprises antenna elements 562. As in a conventional RRU, the first RRU 560 communicates digitized radio data (e.g. CPRI flows) with a DU. In this case, the DU processing the baseband data may be in the hybrid RBS 500 or in the centralized DUs 106, 107, as determined by the configuration of the hybrid RBS 500.

In some examples, a further RRU, second RRU 550 is connected to the system of the hybrid RBS 500 and first RRU 560. The second RRU 550 comprises a radio unit 553 and antenna elements 552. In this example, the second RRU 550 is connected to the first RRU 560 with a second radio data link 520. Radio data (e.g. CPRI) is transmitted along the second radio data link 520, passes through the first RRU 560, and onto the hybrid RBS 500 via the first radio data link 510. In this example, baseband processing for the RBS 500, first RRU 560 and second RRU 550 is carried out in the RBS 500, i.e. by DU 502. The RBS 500 is configured to output or receive backhaul data (i.e. packet data) for all of the RBS 500, first RRU 560 and second RRU 550. For example, a Gigabit Ethernet is used for backhaul from the hybrid RBS 500. The interface 111 for backhaul packet data, and interface 112, is as described above

In this example, joint processing is done at the local DU and the processed traffic is sent to the hub node. In particular, the jointly processed traffic is sent to packet switch 434. The traffic is sent as backhaul, or packet, data, e.g. Ethernet (i.e. not CPRI). The hybrid RBS may be considered as jointly processing the traffic.

FIG. 9b shows an example of radio data traffic from RRUs and a hybrid RBS is sent to the centralized baseband processing (e.g. via CPRI). The radio data flows may be multiplexed at the remote node 431, for example, on a single transport channel (e.g. sharing a wavelength). Alternatively, the radio data traffic from the first and second RRUs 560, 550 is multiplexed at the hybrid RBS 500, prior to transmitting to the centralized DUs 106, 107 for baseband processing. The RRUs and hybrid RBS may be considered as a block of RRUs. The remote node 431 may functions as a multiplexer (e.g. CPRI multiplexer) configured to collect a plurality of data flows (e.g. 3×2.5 G CPRI flow), for transport to towards the BBH 116. For example, the data flows are framed in an optical channel (e.g. 10 G lambda) towards the BBH 116. Multiplexing of data flows may be carried out by the hybrid RRU, remote node 431 or one or more further nodes.

FIG. 9c shows a plurality of RRUs may be added to the same coordination context of the hybrid RBS, by a network configured to process the radio traffic at a centralized baseband pool which handles the hybrid RBS traffic. In this example, additional RRUs 570 may be added to the access network, e.g. to the same coordination cluster, and share the BBH 116. This allows for over-provisioning of coordinated radio nodes, e.g. adding coordinated small-cells under the umbrella of macro-cells, even on an existing network. The further one or more RRUs 570, for example arranged in one or more clusters, are connected to the same BBH 116. For example, the RRUs are all connected through the same remote node 431 or a plurality of remote nodes. The RRUs may be located at one or more different sites to the hybrid RBS. Multiplexing of data flows may be carried out by the hybrid RRU, remote node 431 or one or more further nodes.

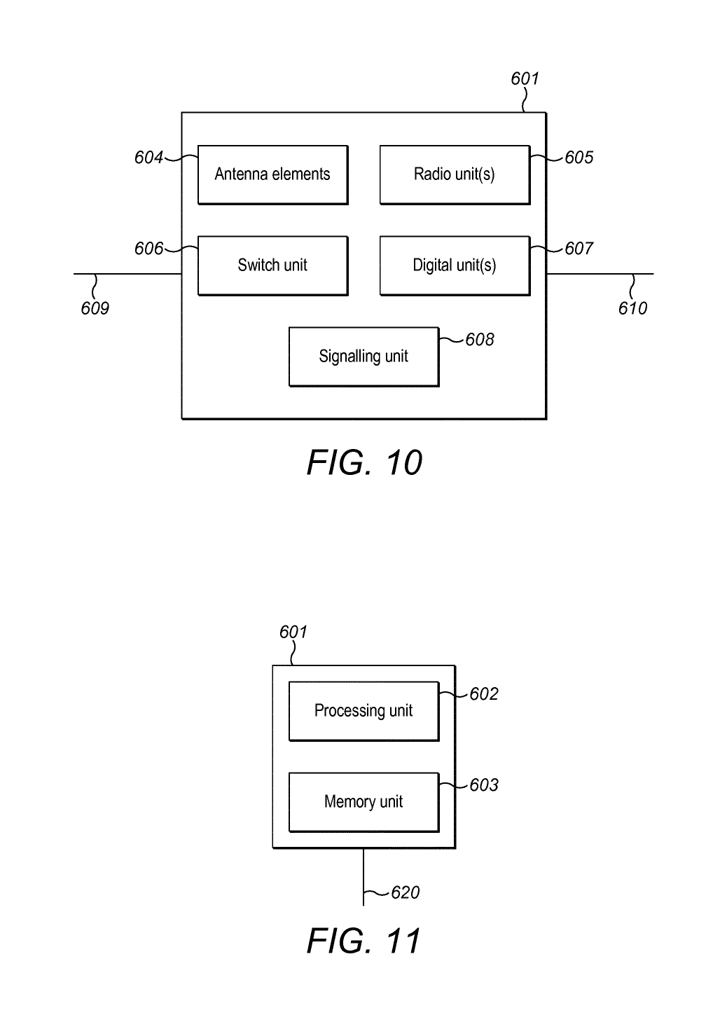

FIG. 10 shows an example hybrid RBS 601 to carry out the functions of the methods described herein. The apparatus comprises at least one Radio Unit 605 which may be multi-standard or multi-radio access technology (RAT) for example WCDMA and LTE (OFDMA), at least one Digital Unit 607 and a Switch Unit 606, an external backhaul network interface 609, for example Ethernet, and optionally, an external fronthaul network interface 610, for example CPRI, for communication with one or more further RRU or RBS. The RBS 601 may comprise a Signalling Unit to send and receive control signals for example to trigger the RBS to change its mode of operation.

FIG. 11 shows a logical example hybrid RBS 601 comprises Processing Unit 602 and a Memory Unit 603.

The example hybrid RBS 601 includes a communication interface 620, a processing unit 602 and an associated computer-readable medium (or media) 603 (e.g., one or more types of memory and/or storage devices, such as a mix of volatile, working memory and non-volatile configuration and program memory or storage). Example memory or storage devices include FLASH, EEPROM or Solid State Disk (SSD), for non-volatile storage, and DRAM or SRAM devices for volatile, working memory.

The communication interface 620 may comprise a mix of analog and digital circuits. For example, the receiver e.g. 103 in one or more embodiments comprises a receiver front-end circuit (not explicitly shown in FIG. 11) that generates one or more streams of digital signal samples corresponding to antenna-received signals, and further includes one or more receiver processing circuits e.g., baseband digital processing circuitry and associated buffer memory which operate on the digital samples. Example operations include linearization or other channel compensation, possibly with interference suppression, and symbol demodulation/detection and decoding, for recovering transmitted information.

The hybrid RBS 601 further includes a processing unit 602 that is operatively associated with the communication interface 620. The processing unit 602 includes or is associated with a computer-readable medium (or media) 603. The computer-readable medium 603 comprises, for example, a mix of volatile, working memory and non-volatile configuration and program memory. Non-limiting examples of the former include Static RAM or SRAM, while non-limiting examples of the latter include FLASH, EEPROM, and SSD storage.

The processing unit 602 provides, for example, digital baseband processing for the receive (RX) signals and transmit (TX) data and control signals received and transmitted through the communication interface 620. The processing unit 602 in this regard comprises digital processing circuitry and may be implemented as one or more microprocessors, DSPs, ASICs, FPGAs, etc. More generally, the processing unit 602 may be implemented using fixed circuitry or programmed circuitry, or a mix of both. In an example embodiment, the computer-readable medium 603 stores a computer program. The processing unit 602 in such embodiments is at least partly configured according to the disclosure herein, based on its execution of the computer program instructions comprising the computer program. The features shown in FIG. 11 may also be applicable to the control unit.

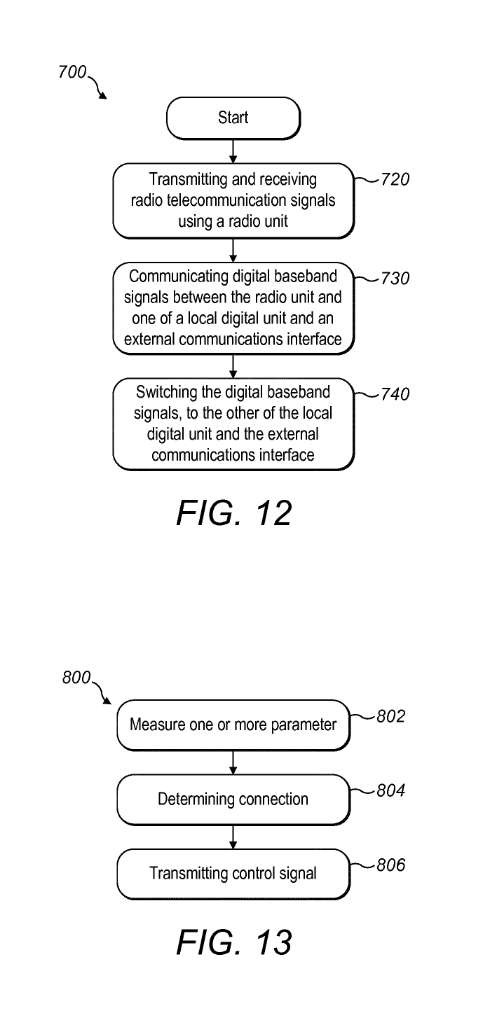

FIG. 12 shows a method 700 in a RBS for configuring the connectivity to change baseband processing from local baseband processing (i.e. in the hybrid RBS) to remote baseband processing (i.e. in a centralized BBH 116). The method starts at 710, in which the hybrid RBS is arranged to perform baseband processing locally or remotely. The hybrid RBS is transmitting and receiving 720 radio telecommunication signals using an RU, and communicating digital baseband signals between the radio unit and one of a local DU and an external communications interface 730.

In 740, the method comprises switching the digital baseband signals such that the digital baseband signals are communicated between the radio unit and the other of the local Digital Unit and an external communications interface. In some examples, the switching is triggered by receiving a control signal, or determining within the hybrid RBS to switch the traffic. The hybrid RBS then continues by communicating the digital baseband signals with the new configuration of switch, connecting the radio unit to the other of the local Digital Unit and the external communications interface.

FIG. 13 shows an exemplary method 800 in a Radio Access Network. In some examples, the method is implemented by the central control unit. In further examples, some or all of the steps are implemented in the Radio Base Station, or in one or more further nodes. The method comprises measuring (802) one or more parameter. As discussed above, the parameter may be one or more of a traffic load in the local DU or the at least one remote Digital Unit; a cell cluster coordination requirement; latency, jitter, and/or uplink/downlink symmetry; a failure in the local Digital, a failure in the remote Digital Unit, and/or a failure in a communication link between the radio unit and the remote Digital Unit; a routine or ad hoc maintenance of one or more Digital Units, and/or; a time schedule criteria. The parameter value may be determined by the control unit, or received by the control unit.

In 804, the method determines for a radio base station that digital baseband signals are communicated between a radio unit and a local Digital Unit or at least one remote Digital Unit. The determining is based on the one or more parameter. Thus, the intended mode of the switch unit of the radio base station is determined.

In 806, the method comprises transmitting (806) a control signal to the radio base station or to the switch unit. The determined connection, implemented by the switch unit, for the digital baseband signals is controlled by the control signal.

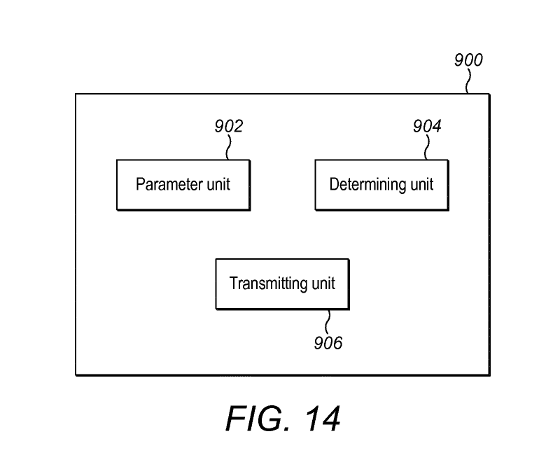

FIG. 14 shows an example apparatus 900, for example, a central control unit 108. The central control unit may also be referred to as a control unit. The apparatus 900 comprises a plurality of logical functions. In some examples, the functions are carried out by a processing arrangement (e.g. a semiconductor processor) and a memory.

The apparatus 900 comprises a parameter unit 902 configured to determine one or more parameter. As discussed above, the parameter may be one or more of a traffic load in the local DU or the at least one remote Digital Unit; a cell cluster coordination requirement; latency, jitter, and/or uplink/downlink symmetry; a failure in the local Digital, a failure in the remote Digital Unit, and/or a failure in a communication link between the radio unit and the remote Digital Unit; a routine or ad hoc maintenance of one or more Digital Units 203, 303, and/or; a time schedule criteria. The parameter value may be determined by the control unit, or received by the control unit. For example, the parameter value may be measured by the radio base station, and transmitted to the control unit to determine the location of the baseband processing.

The apparatus further comprises a determining unit 904 configured to determine for a radio base station that digital baseband signals are communicated between a radio unit and a local Digital Unit or between the radio unit and at least one remote Digital Unit. The determining unit is configured to determine which connection the switch unit makes, based on the one or more parameter.

The apparatus 900 further comprises a transmitting unit 906 configured to transmit a control signal to the radio base station to select the connection for the digital baseband signals. In some examples, the transmitting unit transmits the control signal to the switch unit, e.g. if the control unit is in the radio base station. In some examples, the transmitting unit transmits to the signaling unit of the radio base station.

The foregoing embodiments may be implemented in separate logical elements as herein described or in other combinations thereof.

Aspects of the disclosure provide for a dynamic determination and selection of which group of cells (provided by a RBS/RRU) have radio coordination (e.g. using centralized baseband processing). This is not possible by using a base station with a fixed baseband processing resource. Over-provisioning of coordinated radio nodes (for example adding coordinated small-cells under the umbrella of macro-cells) is possible, even if not planned in advance. Aspects allow the radio coordination to be independent from the radio node type and from the underlying transport network. The hybrid RBS allows coordination clusters to be changed in a common fronthaul area.

In a further example of the disclosure, a system for handling communication in a radio access network comprises at least one Radio Base Station 101. The Radio Base Station 101 is as described in any example. The system further comprises at least one remote Digital Unit 106, 107 configured to process baseband signals. The Radio Base Station 101 comprises the Radio Unit 103 configured to transmit or receive radio communication signals, and the local Digital Unit 105 configured to process digital baseband signals sent to and received from the Radio Unit. An external communications interface 112 is configured to connect the at least one remote Digital Unit 106, 107 with the Radio Unit of the Radio Base Station. The system is configured to selectively connect the Radio Unit with said at least one Digital Unit, via the external interface, or with the local Digital Unit 103. In some examples, the system further comprises the control unit 108. For example, the control unit controls the switch unit of a plurality of the base stations, e.g. by transmitting control signals to each radio base station 101.

In some aspects, the central control unit or other parts of the network or system described is implemented using Software Defined Networking (SDN). For example, the central control unit is an SDN orchestrator.

1-17. (canceled)

18. A radio base station for a radio telecommunications network, the radio base station comprising:
a Radio Unit configured to transmit and receive radio telecommunication signals;
a Switch Unit;
a local Digital Unit configured to process digital baseband signals received from the Radio Unit and generate digital baseband signals sent to the Radio Unit;
an external communications interface configured to connect at least one remote Digital Unit to the Radio Unit of the radio base station;
wherein the switch unit is configured to selectively connect the Radio Unit with the local Digital Unit or the external communications interface.

19. The radio base station of claim 18, further comprising a network interface wherein the network interface connects the local Digital Unit to a backhaul connection.

20. The radio base station of claim 18:
further comprising a second external interface, wherein the second external interface provides for communication of digital baseband signals with one or more Remote Radio Units;
wherein the radio base station is configured to selectively provide the one or more remote Radio Units with baseband processing in the local Digital Unit or provide an interface for baseband processing in the remote Digital Unit.

21. The radio base station of claim 18, wherein the external communications interface comprises a Common Public Radio Interface (CPRI) interface.

22. The radio base station of claim 18, wherein the switch unit is configured to receive a control signal from a central control unit;
selectively connect the Radio Unit with the local Digital Unit or the external communications interface based on the control signal.

23. The radio base station of claim 18, wherein the switch unit is configured to selectively connect the Radio Unit with the local Digital Unit or the external communications interface for communication of digital baseband signals based on a determination of one or more of:
a traffic load in the local Digital Unit or the at least one remote Digital Unit;
a cell cluster coordination requirement;
latency, jitter, and/or uplink/downlink symmetry;
a failure in the local Digital Unit, a failure in the remote Digital Unit, and/or a failure in a communication link between the radio unit and the remote Digital Unit;
a routine or ad hoc maintenance of one or more Digital Units; and/or
a time scheduled criteria.

24. A method in a radio base station, the method comprising:
transmitting and receiving radio telecommunication signals using a radio unit;
communicating digital baseband signals between the radio unit and one of a local Digital Unit and an external communications interface, wherein the external communications interface connects the radio unit to at least one remote Digital Unit,
selecting a different connection for the digital baseband signals, such that the digital baseband signals are communicated between the radio unit and the other of the local Digital Unit and the external communications interface.

25. The method of claim 24, further comprising receiving a control signal from a central control unit, wherein the selected connection is controlled by the control signal.

26. The method of claim 24, further comprising connecting the local Digital Unit with one or more Remote Radio Unit, wherein the radio base station provides the one or more Remote Radio Unit with baseband processing in the local Digital Unit.

27. The method of claim 24, further comprising determining the connection for the digital baseband signals based on a determination of one of:
a traffic load in the local DU or the at least one remote Digital Unit;
a cell cluster coordination requirement;
latency, jitter, and/or uplink/downlink symmetry;
a failure in the local Digital, a failure in the remote Digital Unit, and/or a failure in a communication link between the radio unit and the remote Digital Unit;
a routine or ad hoc maintenance of one or more Digital Units; and/or
a time schedule criteria.

28. A method in a Radio Access Network (RAN), the method comprising:
measuring one or more parameters;
determining, for a radio base station, a connection for digital baseband signals to be communicated between a radio unit and a local Digital Unit or at least one remote Digital Unit, wherein the determining is based on the one or more parameters; and
transmitting a control signal to a switch unit of the radio base station, the control signal controlling a digital baseband signal connection between the radio unit and the local Digital Unit or the at least one remote Digital Unit.

29. The method of claim 28, wherein the determining the connection for a radio base station is performed in a central control unit.

30. The method of claim 28, wherein the determining the connection for the digital baseband signals is based on a determination of one of:
a traffic load in the local DU or the at least one remote Digital Unit;
a cell cluster coordination requirement;
latency, jitter, and/or uplink/downlink symmetry;
a failure in the local Digital, a failure in the remote Digital Unit, and/or a failure in a communication link between the radio unit and the remote Digital Unit;
a routine or ad hoc maintenance of one or more Digital Units; and/or
a time schedule criteria.

31. The method of claim 28:
wherein the radio access network comprises a plurality of radio base stations;
further comprising configuring a group of a plurality of the plurality of radio base stations to be connected to a common baseband processing pool of one or more of the remote Digital Units; and
further comprising selecting a different connection for the digital baseband signals of one or more of the radio base stations to modify the group of one or more radio base stations connected to the common baseband processing pool.

32. A control unit for a Radio Access Network, the control unit comprising:
processing circuitry;
memory containing instructions executable by the processing circuitry whereby the control unit is operative to:
determine one or more parameters;
determine, for a radio base station, a connection for digital baseband signals to be communicated between a radio unit and a local Digital Unit or between the radio unit and at least one remote Digital Unit, wherein the determining is based on the one or more parameters; and
transmit a control signal to the radio base station to select the connection for the digital baseband signals.

33. The control unit of claim 32, wherein the parameter is one or more of:
a traffic load in the local DU or the at least one remote Digital Unit;
a cell cluster coordination requirement;
latency, jitter, and/or uplink/downlink symmetry;
a failure in the local Digital, a failure in the remote Digital Unit, and/or a failure in a communication link between the radio unit and the remote Digital Unit;
a routine or ad hoc maintenance of one or more Digital Units; and/or
a time schedule criteria.

34. The control unit of claim 32, wherein the control unit is a part of a Software Defined Networking (SDN) network.

35. A non-transitory computer readable recording medium storing a computer program product for controlling a radio base station, the computer program product comprising software instructions which, when run on processing circuitry of the radio base station, causes the radio base station to:
transmit and receive radio telecommunication signals using a radio unit;
communicate digital baseband signals between the radio unit and one of a local Digital Unit and an external communications interface, wherein the external communications interface connects the radio unit to at least one remote Digital Unit,
select a different connection for the digital baseband signals, such that the digital baseband signals are communicated between the radio unit and the other of the local Digital Unit and the external communications interface.

36. A non-transitory computer readable recording medium storing a computer program product for controlling a Radio Access Network (RAN), the computer program product comprising software instructions which, when run on processing circuitry of the RAN, causes the RAN to:
measure one or more parameters;
determine, for a radio base station, a connection for digital baseband signals to be communicated between a radio unit and a local Digital Unit or at least one remote Digital Unit, wherein the determining is based on the one or more parameters; and
transmit a control signal to a switch unit of the radio base station, the control signal controlling a digital baseband signal connection between the radio unit and the local Digital Unit or the at least one remote Digital Unit.
